(19) United States
(12) Patent Application Publication
(10) Pub. No.: US 2019/0101258 A1
(43) Pub. Date: Apr. 4, 2019

(54) DUAL-SOURCE LIGHTING SYSTEM

(71) Applicant: CentraLED Technology Co., Ltd., Taoyuan City (TW)

(72) Inventors: Chiu-Fen WANG, Taoyuan City (TW); Xuan-Hao LEE, Taoyuan City (TW)

(21) Appl. No.: 16/150,945

(22) Filed: Oct. 3, 2018

Related U.S. Application Data
(60) Provisional application No. 62/567,404, filed on Oct. 3, 2017.

(51) Int. Cl. F21S 41/16; F21S 41/32; F21V 9/38; B60Q 1/00; F21S 45/47; F21S 41/37; F21S 41/36; F21S 41/25

(52) U.S. Cl. CPC F21S 41/16; F21S 41/321; F21V 9/38; B60Q 1/0023; F21W 2102/13; F21S 41/37; B60Q 1/0076; F21S 41/36; F21S 41/25; F21S 45/47

(57) ABSTRACT

The present invention is a dual-source lighting system, comprising: an illumination system comprising: a semi-elliptical reflector; a cover; a first light wavelength conversion layer and a second light wavelength conversion layer, respectively disposed on a focus and a second focus of the cover; a laser light source, projecting to the first light wavelength conversion layer to generate a first excitation light and forming a plurality of reflected lights which are re-focused on the second light wavelength conversion layer and generating a second excitation light; and an image detection system that reads the image signals and relative position information after illumination.

This application claims priority to U.S. Provisional Application No. 62/556,404 filed on Oct. 3, 2017, and which is hereby incorporated by reference in its entirety.

### BACKGROUND OF THE INVENTION

### 1. Technical Field

The invention relates to a dual-light source lighting system, in particular to a dual-light source lighting system applied to a self-drive car for ambient illumination and detection outside the self-drive car body.

### 2. Description of Related Art

Self-driving cars, also known as driverless cars, computer-driven cars or wheeled mobile robots, are a kind of unmanned ground vehicle for transporting power. As an automated vehicle, autonomous vehicles can sense their environment and navigation without human intervention.

Self-driving cars can sense their environment with technologies such as radar, optical lighting, GPS, and computer vision. Advanced control systems convert sensory data into appropriate navigational roads, as well as obstacles and related signs. By definition, autonomous vehicles can update their map information by sensing the input data so that the vehicle can keep track of its location.

### SUMMARY OF THE INVENTION

The invention relates to a dual-light source lighting system, which mainly solves the problem of how to provide illumination of visible light and invisible light of a self-drive car, and thereby dynamically detecting the environment information outside the self-drive car.

This present invention provides a dual-source lighting system, wherein an illumination system comprising: a semi-elliptical reflector having a first opening; a cover formed at the first opening and having a first focus and a second focus of the semi-elliptical reflector; a first light wavelength conversion layer disposed at the first focus; a second light wavelength conversion layer disposed at the second focus; and at least one first laser light source ‘ their emitted laser light projected onto the first light wavelength conversion layer to produce a first excitation light and multiple reflected lights’ the multiple reflected lights reflected by the semi-elliptical reflector will again focus on the second light wavelength conversion layer to excite a second excitation light.

Implementation of the present invention at least produces the following advantageous effects:

1. It can provide visible light illumination to the outside of the vehicle.
2. It can provide illumination of invisible light outside the vehicle.
3. The image detection system can read the image signal and the relative position information of the illumination area by the aid of the visible light or the invisible light.

The features and advantages of the present invention are detailed hereinafter with reference to the preferred embodiments. The detailed description is intended to enable a person skilled in the art to gain insight into the technical contents disclosed herein and implement the present invention accordingly. In particular, a person skilled in the art can easily understand the objects and advantages of the present invention by referring to the disclosure of the specification, the claims, and the accompanying drawings.

### BRIEF DESCRIPTION OF THE DRAWINGS

FIG. 1 is a first embodiment of a Lighting System 1 of a dual-source lighting system of the present invention;

FIG. 2 is a second embodiment of a Lighting System 1 of a dual-source lighting system of the present invention;

FIG. 3 is a third embodiment of a Lighting System 1 of a dual-source lighting system of the present invention;

FIG. 4 is a Lighting System 2 embodiment of a dual light source illumination system of the present invention;

FIG. 5 is a Lighting System 3 embodiment of a dual light source illumination system of the present invention;

FIG. 6 is a Lighting System 4 embodiment of a dual light source illumination system of the present invention;

FIG. 7 is a Lighting System 5 embodiment of a dual light source illumination system of the present invention;

FIG. 8 is a Lighting System 6 embodiment of a dual light source illumination system of the present invention;

FIG. 9 is a top view of the FIG. 8;

FIG. 10 is a top view having heat dissipation module of the FIG. 8;

FIG. 11 is a first embodiment of Lighting System 7 of a dual-source lighting system of the present invention;

FIG. 12 is a second embodiment of Lighting System 7 of a dual-source lighting system of the present invention;

FIG. 13 is a third embodiment of Lighting System 7 of a dual-source lighting system of the present invention;

FIG. 14a is a top view of the first embodiment of FIG. 11;

FIG. 14b is a top view of the second embodiment of FIG. 12;

FIG. 14c is a top view of the third embodiment of FIG. 13;

FIG. 14d is a top view having heat dissipation module of FIG. 11;

FIG. 14e is a top view having heat dissipation module of FIG. 12;

FIG. 14f is a top view having heat dissipation module of FIG. 13;

FIG. 15 is a Lighting System 8 embodiment of a dual-source lighting system of the present invention.

### DETAILED DESCRIPTION OF THE INVENTION

[symbol] Lighting System 1 or 2

[symbol]

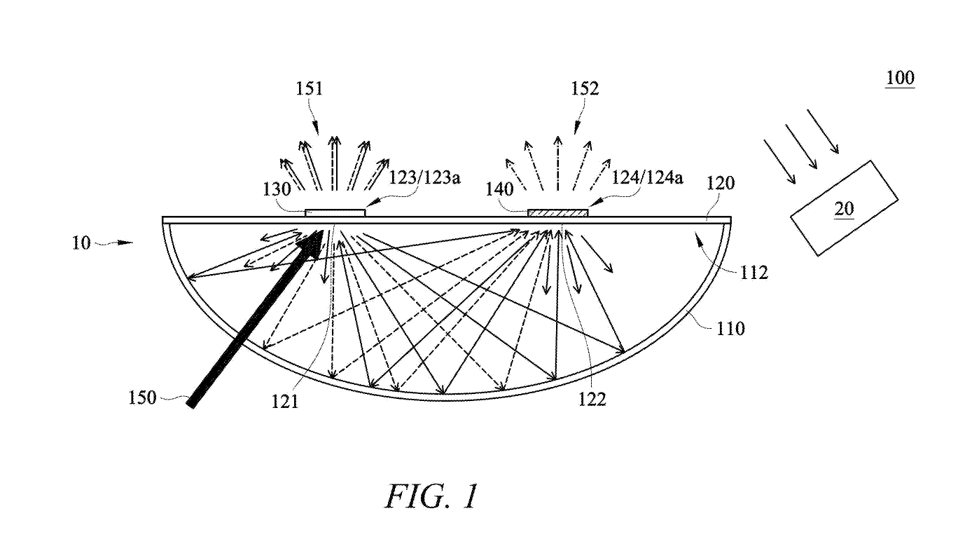

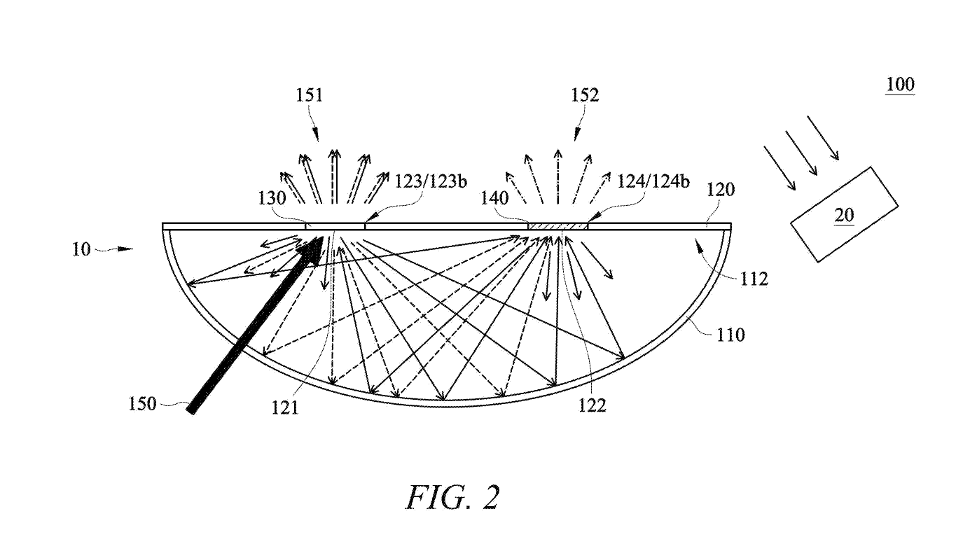

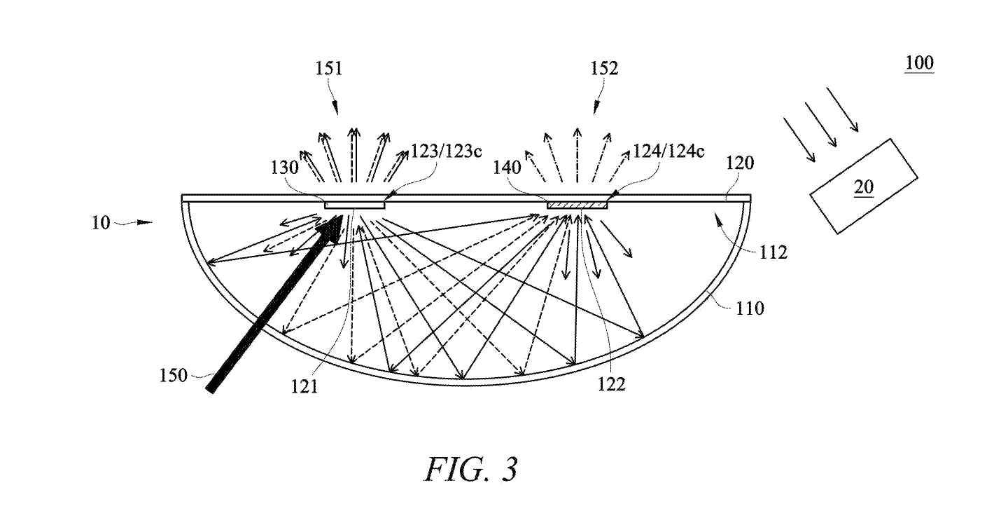

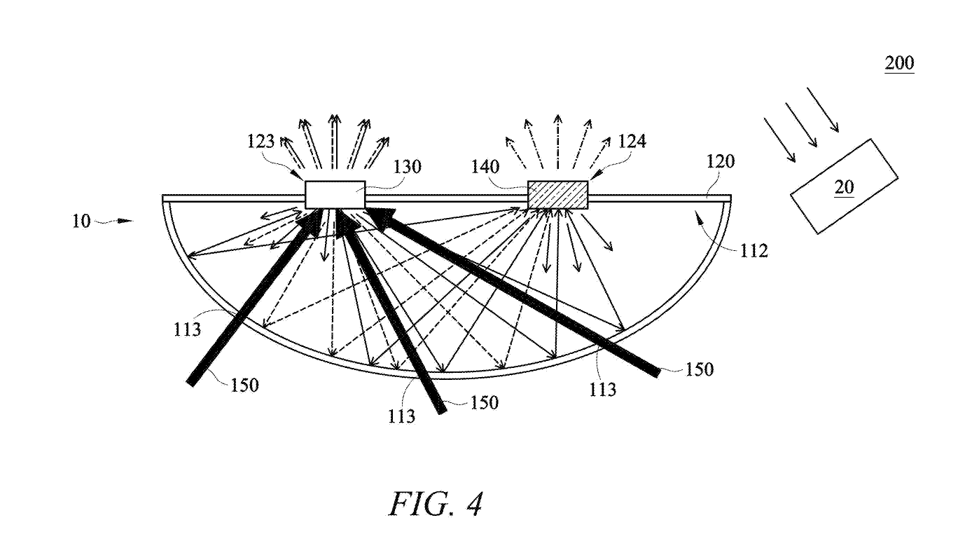

As shown in FIGS. 1-4, these embodiments are dual-source lighting system 100,200 comprising: an illumination system 10 and an image detection system 20. The illumination system 10 further comprise a semi-elliptical reflector 110; a cover 120; a first optical wavelength conversion layer 130; a second light wavelength conversion layer 140; and at least one first laser light source 150.

The semi-elliptical reflector 110 is half of the ellipse along the long axis of the ellipse and has a first opening 112. Any ellipses form with two focuses inside.

The cover 120 formed at the first opening 112, so that the two focuses inside the ellipse will form a first focus 121 and a second focus 122 on the cover 120.

The first light wavelength conversion layer 130 is disposed at the first focus 121; and the first light wavelength conversion layer 130 may be a yellow, red-green mixed, or orange-green mixed phosphor layer. The first light wavelength conversion layer 130 can also be a material layer formed by a quantum dot layer or a photoluminescent material. Regarding the position of the installation, the first light wavelength conversion layer 130 may be disposed on a first position 123 which is on the outer side 123a of the cover 120, embedded inside 123b the cover 120, or on the inner side 123c of the cover 120.

The second light wavelength conversion layer 140 is disposed at the second focus 122; and the second light wavelength conversion layer 140 may be an infrared fluorescent powder layer. The second light wavelength conversion layer 140 can also be a material layer formed by a quantum dot layer or a photoluminescent material. Regarding the position of the installation, the second light wavelength conversion layer 140 may be disposed on a second position 124 which is on the outer side 124a of the cover 120, embedded inside 124b the cover 120, or on the inner side 124c of the cover 120.

At least one first laser light source 150, their emitted laser light project onto the first light wavelength conversion layer 130, such that can excite, for example, one of the visible white light, the first excitation light 151. At this time, part of the laser light will be scattered to form a plurality of reflected lights at different angles.

When the scattered reflected lights scattered into the interior of the semi-elliptical reflector 110, after reflected again by the semi-elliptical reflector 110, the scattered reflected lights will again focus on the second focus 122 that is on the second light wavelength conversion layer 140. Thus, the second light wavelength conversion layer 140 will be excited and a second excitation light 152 such as invisible infrared light will generate.

The above-mentioned laser light source 150 may be disposed inside the semi-elliptical reflector 110, or may be disposed outside the semi-elliptical reflector 110 which has at least one light entrance hole 113. Further, each of the light entrance hole 113 corresponds to a laser light source 150, so that the laser light source 150 can inject the laser light from the outside of the semi-elliptical reflector 110.

Regarding the image detection system 20, when the visible white light or the invisible infrared light generated by the illumination system 10 projects on a target area. The objects in the target area are thus illuminated or detected, so the image detection system 20 can read the objects in the target area. The image detection system 20 can be used to read the image signals and relative position information in the illumination area of the illumination system 10.

[symbol]

Lighting System 3

[symbol]

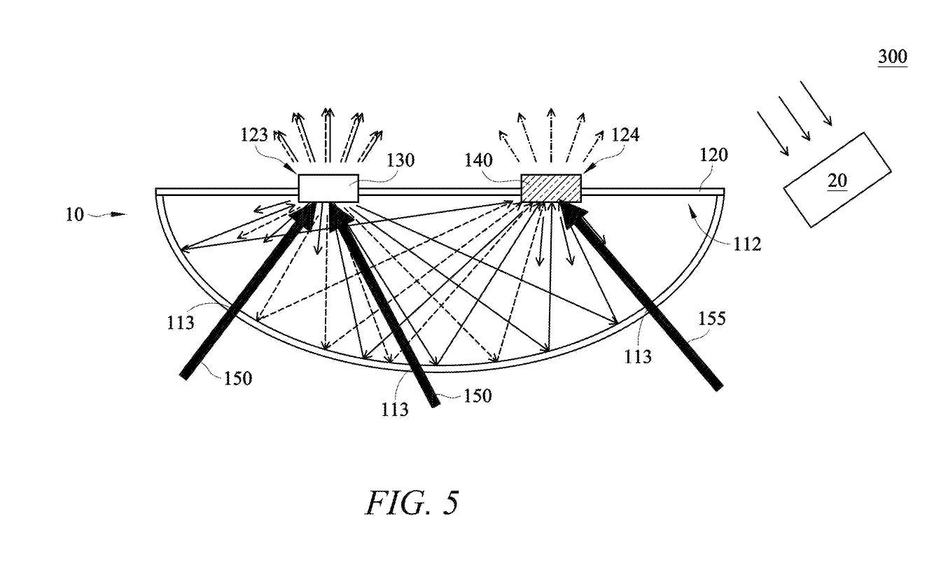

As shown in FIG. 5, based on the above-mentioned architecture of Lighting System 1 or 2, in any of architectures, dual-source lighting system 300 can further comprise a second laser source 155 and the second laser source 155 can directly project to the second light wavelength conversion layer 140, and thus a second excitation light 152 can be generated. Similarly, there will be a port of the laser light that will be scattered to form a plurality of reflected lights at different angles.

When the plurality of reflected lights are scattered into the interior of the semi-elliptical reflector 110, after being reflected again by the semi-elliptical reflector 110, they will again focus on the first focus 121, that is, on the first light wavelength conversion layer 130, thus exciting the first light wavelength conversion layer 130 and producing the first excitation light 151.

[symbol]

Lighting System 4

[symbol]

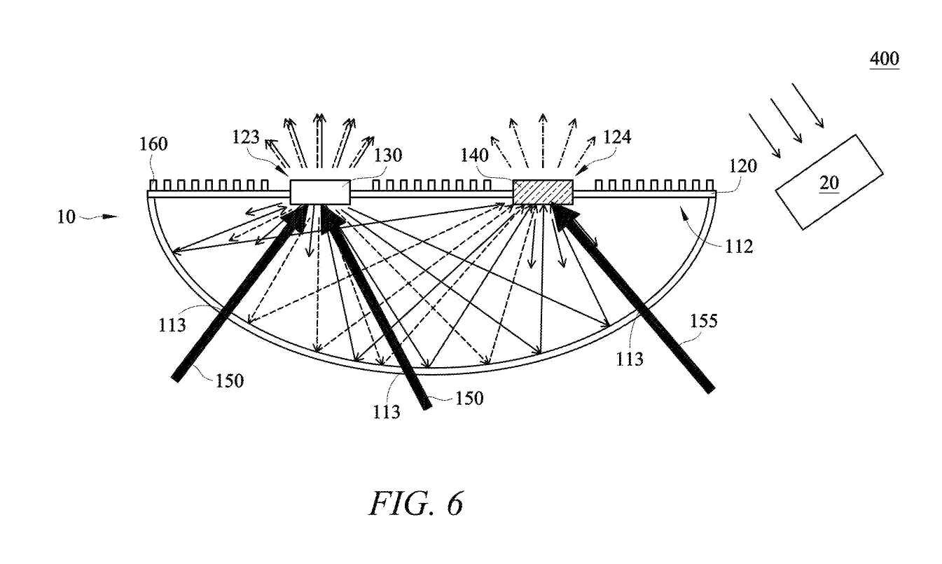

As shown in FIG. 6, based on the above-mentioned architecture of Lighting System 1, 2, or 3, in any of architectures, dual-source lighting system 400 can further has a heat dissipation module 160 disposed on the outer side of the cover 120. So that the heat generated by the first light wavelength conversion layer 130 and the second light wavelength conversion layer 140 during the excitation process can be effectively eliminated, thereby ensuring stable operation of the first light wavelength conversion layer 130 and the second light wavelength conversion layer 140. The heat dissipation module 160 described above may be composed of a heat dissipation fin, a heat pipe, or a micro flow channel or the combination of at least two of the above three.

[symbol]

Lighting System 5

[symbol]

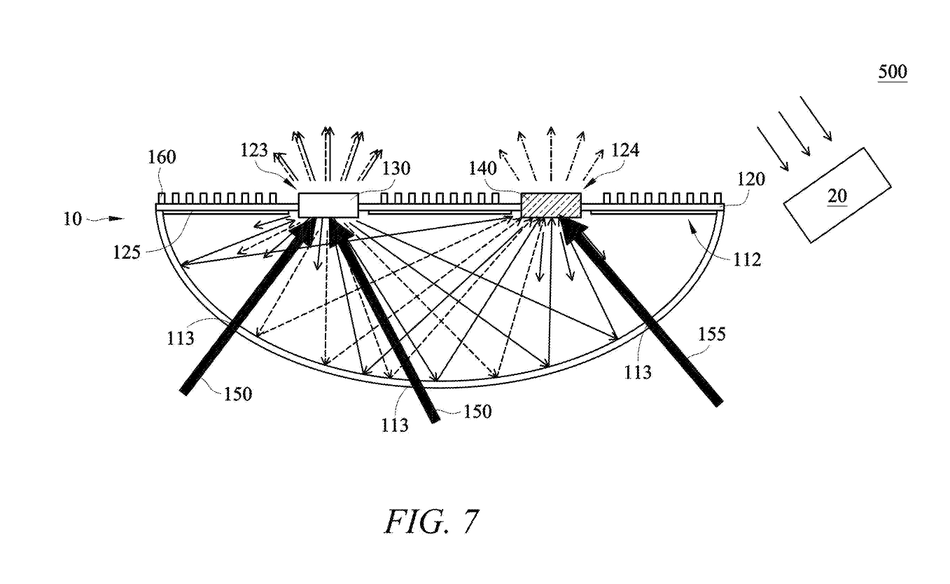

As shown in FIG. 7, based on the above-mentioned architecture of Lighting System 1, 2, 3, or 4, in any of the structures, dual-source lighting system 500 can further has optical element 125, for example, a reflective sheet (RS) or a reflective film (RF) or an anti-reflective coating layer (ARCL) disposed on the inner side of the cover 120.

[symbol]

Lighting System 6

[symbol]

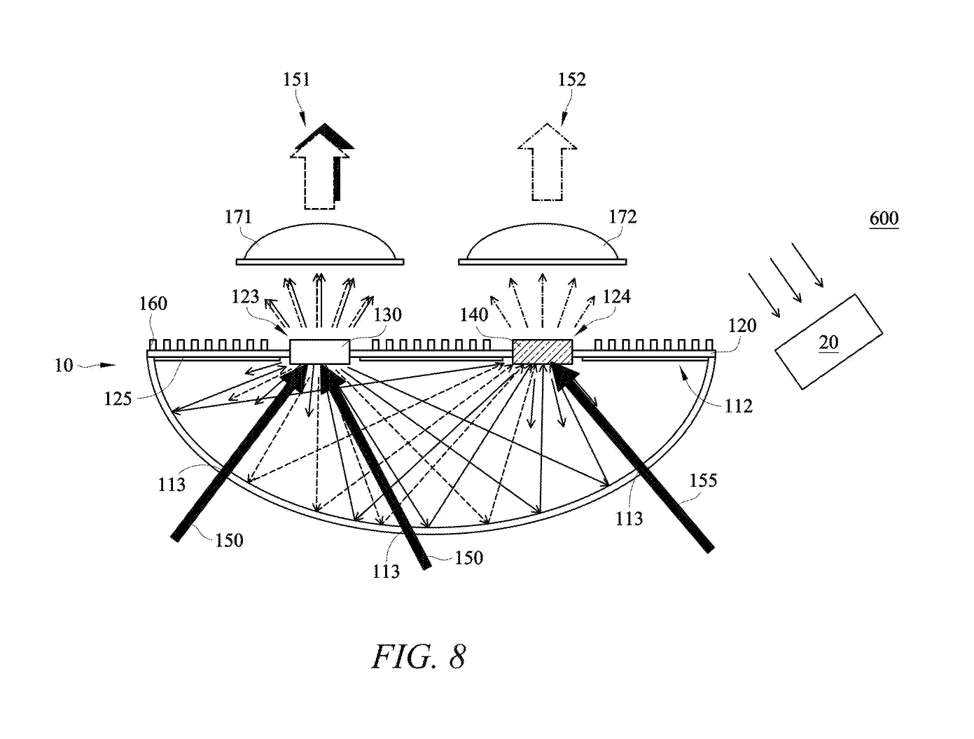

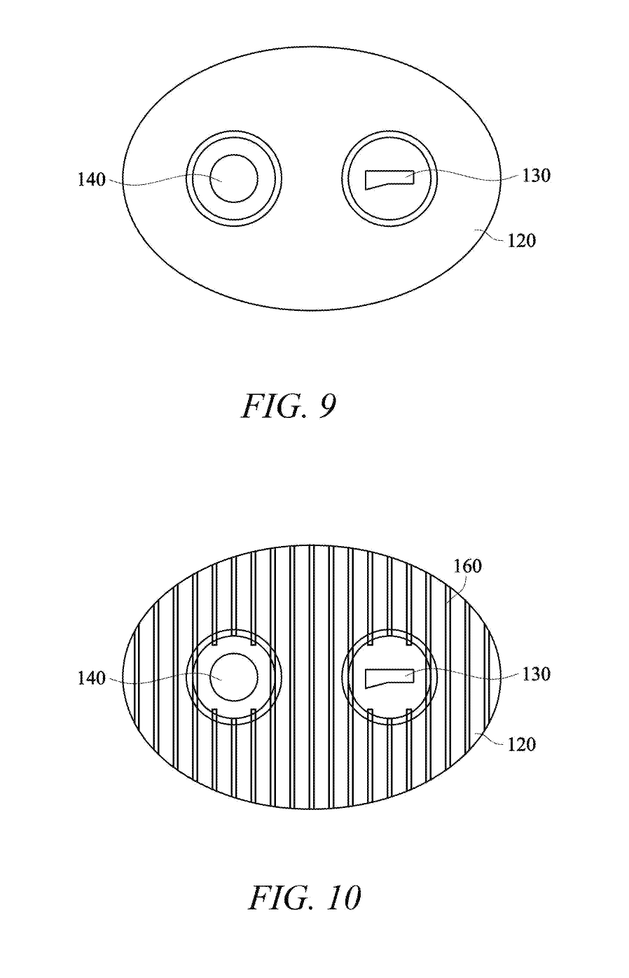

As shown in FIG. 8-10, based on the above architecture of Lighting System 1, 2, 3, 4, or 5, in any of structures, dual-source lighting system 600 can further has a Lens for Low Beam (LLB) 171 disposed on the light emitting side of the first light wavelength conversion layer 130. At this time, the shape of the first light wavelength conversion layer 130 can be a shape conforming to the specification of the near lamp product. Dual-source lighting system 600 can also further has a Lens for High Beam (LHB) 172 may be further disposed on the light emitting side of the second light wavelength conversion layer 140.

[symbol]

Lighting System 7

[symbol]

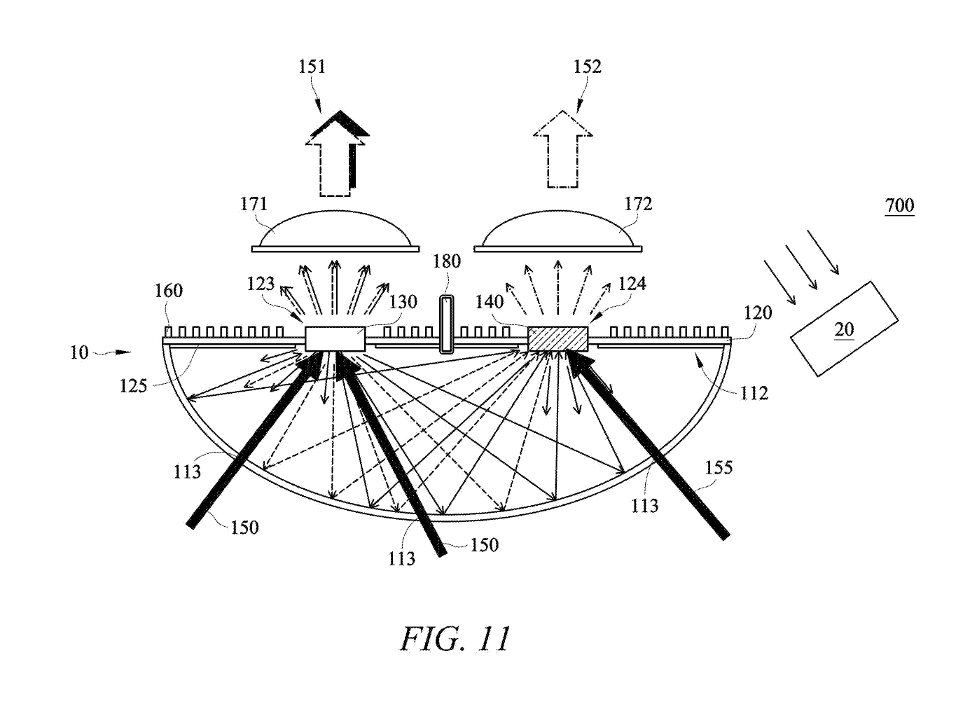

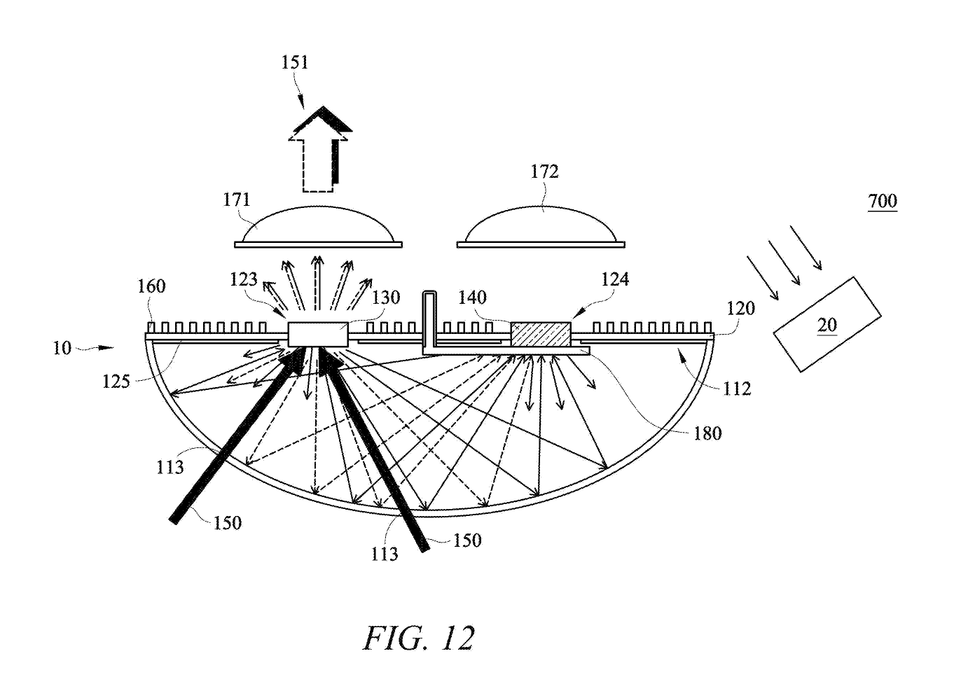

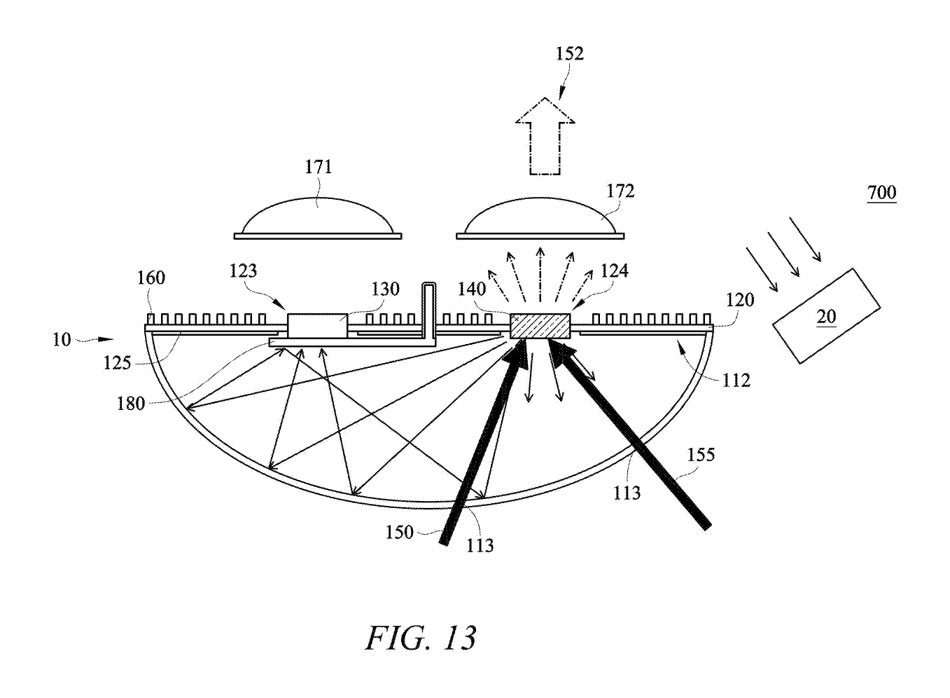

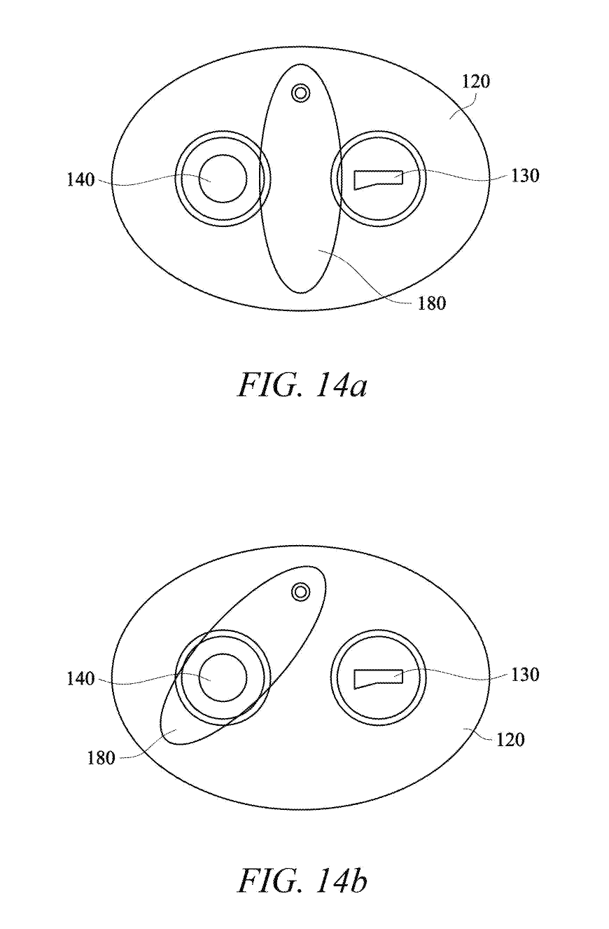

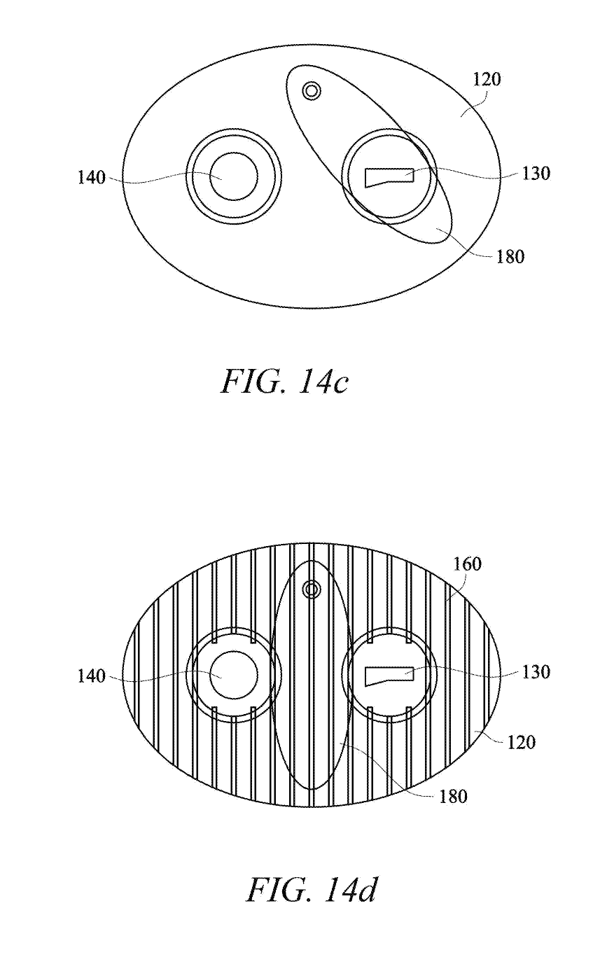

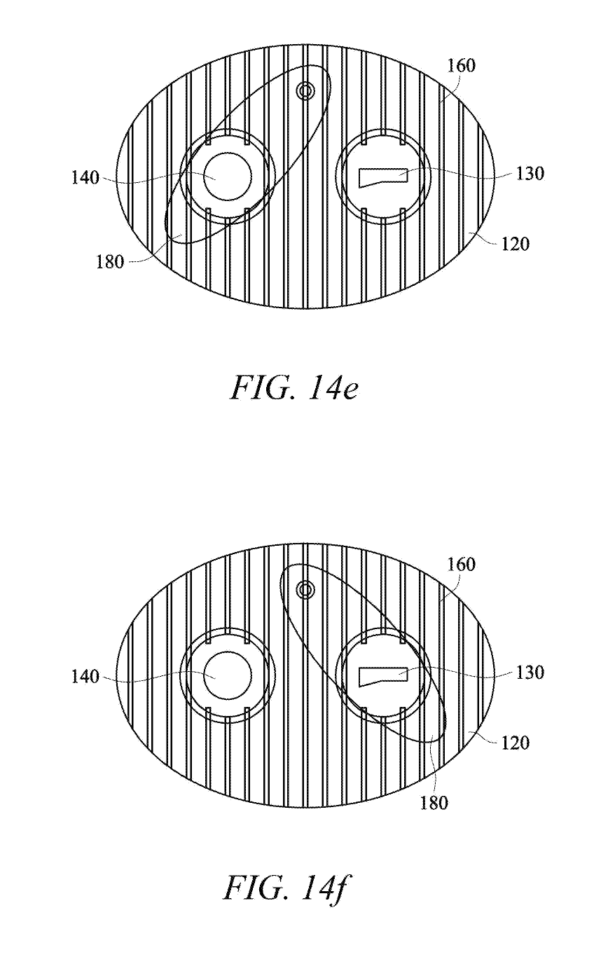

As shown in FIGS. 11-13 and FIG. 14a-14f, based on the above-mentioned architecture of Lighting System 1, 2, 3, 4, 5, or 6, in any of structures, dual-source lighting system 700 can further has a light switch 180 disposed inside the cover 120 to selectively control the first light wavelength conversion layer 130 or the second light wavelength conversion layer 140 to be simultaneously excited or selectively excited. The optical switch can be a rotating or mobile light interrupter.

[symbol]

Lighting System 8

[symbol]

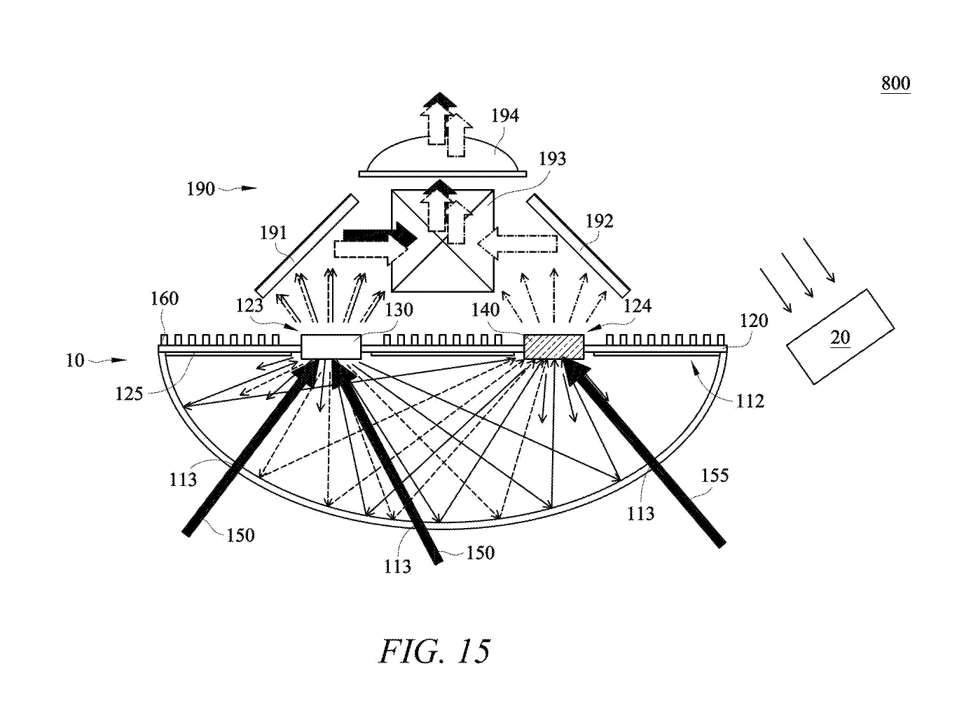

As shown in FIG. 15, based on the above-mentioned architecture of Lighting System 1, 2, 3, 4, 5, or 7, any of the architectures, dual-source lighting system 800 can further has an optical integration module 190, comprising: a first mirror 191 disposed on the light exit side of the first light wavelength conversion layer 130; a second mirror 192 disposed on the light exit side of the second light wavelength conversion layer 140; an X Cube 193 receiving the reflected lights of the first mirror 191 and the second mirror 192 to generate a mixed light; and a light projecting lens 194 disposed on the light path of the mixed light.

The above description is only the preferred embodiments of the present invention, and is not intended to limit the present invention in any form. Although the invention has been disclosed as above in the preferred embodiments, they are not intended to limit the invention. A person skilled in the relevant art will recognize that equivalent embodiment modified and varied as equivalent changes disclosed above can be used without parting from the scope of the technical solution of the present invention. All the simple modification, equivalent changes and modifications of the above embodiments according to the material contents of the invention shall be within the scope of the technical solution of the present invention.

What is claimed is:

1. A dual-source lighting system, wherein an illumination system comprising:
a semi-elliptical reflector having a first opening;
a cover formed at the first opening and having a first focus and a second focus of the semi-elliptical reflector;
a first light wavelength conversion layer disposed at the first focus;
a second light wavelength conversion layer disposed at the second focus; and
at least one first laser light source, their emitted laser light projected onto the first light wavelength conversion layer to produce a first excitation light and multiple reflected lights, the multiple reflected lights reflected by the semi-elliptical reflector will again focus on the second light wavelength conversion layer to excite a second excitation light.

2. The dual-source lighting system as claimed in claim 1, further comprise an image detection system which is used to read image signals and relative position information in an illumination area of the illumination system.

3. The dual-source lighting system as claimed in claim 1, wherein the first light wavelength conversion layer is a yellow, red-green mixed, or orange-green mixed phosphor layer.

4. The dual-source lighting system as claimed in claim 1, wherein the second light wavelength conversion layer is an infrared fluorescent powder layer.

5. The dual-source lighting system as claimed in claim 1, wherein the first light wavelength conversion layer is disposed on a first position which is on the inner side of the cover, on the outer side of the cover, or embedded inside the cover.

6. The dual-source lighting system as claimed in claim 1, wherein the second light wavelength conversion layer is disposed on a second position which is on the inner side of the cover, on the outer side of the cover, or embedded inside the cover.

7. The dual-source lighting system as claimed in claim 1, wherein the semi-elliptical reflector has at least one light entrance hole and each of the light entrance hole corresponds to the first laser light source.

8. The dual-source lighting system as claimed in claim 1, further comprise a second laser source and its laser light directly project to the second light wavelength conversion layer to excite a second excitation light and form a plurality of reflected lights which are re-focused on the second light wavelength conversion layer and excite a second excitation light.

9. The dual-source lighting system as claimed in claim 1, further has a heat dissipation module disposed on the outer side of the cover.

10. The dual-source lighting system as claimed in claim 8, wherein the heat dissipation module is composed of a heat dissipation fin, a heat pipe, or a micro flow channel or the combinations of at least two of the above three.

11. The dual-source lighting system as claimed in claim 1, further has a reflective sheet (RS) or a reflective film (RF) or an anti-reflective coating layer (ARCL) disposed on the inner side of the cover.

12. The dual-source lighting system as claimed in claim 1, further has a Lens for Low Beam (LLB) disposed on the light emitting side of the first light wavelength conversion layer and a Lens for High Beam (LHB) disposed on the light emitting side of the second light wavelength conversion layer.

13. The dual-source lighting system as claimed in claim 1, further has a light switch disposed inside the cover to selectively control the first light wavelength conversion layer or the second light wavelength conversion layer to be simultaneously excited or selectively excited and the optical switch is a rotating or mobile light interrupter.

14. The dual-source lighting system as claimed in claim 1, further has an optical integration module, comprise:
a first mirror disposed on the light exit side of the first light wavelength conversion layer;
a second mirror disposed on the light exit side of the second light wavelength conversion layer;
an X Cube receiving the reflected lights of the first mirror and the second mirror to generate a mixed light; and
a light projecting lens disposed on the light path of the mixed light.
